(19) United States
(12) Patent Application Publication
(10) Pub. No.: US 2006/0236744 A1
(43) Pub. Date: Oct. 26, 2006

(54) Method for calibrating an ultrasound flowmeter

(75) Inventors: Achim Wiest, Weil am Rhein (DE); Thomas Froehlich, Munchenstein (CH); Andreas Berger, Therwil (CH); Torsten Strunz, Basel (CH)

Correspondence Address: BACON & THOMAS, PLLC, 625 SLATERS LANE, FOURTH FLOOR, ALEXANDRIA, VA, 22314, US

(73) Assignees: Endress; Endress + Hauser Flowtec AG, Reinach (CH)

(21) Appl. No.: 10/562,220

(22) PCT Filed: Jun. 22, 2004
(86) PCT No.: PCT/EP04/06703

§ 371 Date: May 25, 2006

(30) Foreign Application Priority Data
Jun. 23, 2003 (DE) 10328294.7

(51) Int. Cl. G01F 25/00; G01F 1/50

(52) U.S. Cl. 73/1.34; 702/100

(57) ABSTRACT

A method for the dry calibration of an ultrasonic flow measuring device, wherein, on the basis of predetermined, geometric, production data of the flow measuring device, information concerning the theoretical flow of the medium through a measuring tube is won, actual geometric measurement data of the flow measuring device is three-dimensionally determined, on the basis of the actual geometric measurement data, information concerning the actual flow of the medium through the flow measuring device is won, and, on the basis of the information regarding the theoretical flow, and the actual flow, of the medium through the flow measuring device, a correction, or calibration, factor is determined for the flow measuring device.

The invention relates to a method for calibrating an ultrasonic flow-measuring device. The ultrasonic flow-measuring device has at least one measuring tube, at least two ultrasonic sensors and a control/evaluation unit, wherein the ultrasonic sensors emit and/or receive ultrasonic measuring signals, and wherein the flow, e.g. flow rate, of a medium in the measuring tube is determined on the basis of the travel-time difference of the ultrasonic measuring signals traversing the measuring tube in the stream direction and counter to the stream direction.

Due to tolerances in manufacture, flow measuring devices, especially ultrasonic flow measuring devices, must be calibrated, before being used. Known methods of calibration for ultrasonic flow-measuring devices rest on a so-called wet calibration, i.e. for the purpose of determining the calibration factor of the particular flow-measuring device, a very accurately defined amount of a medium is caused to flow through the measuring device to be calibrated. Depending on the diameter of the measuring tube of the flow-measuring device, relatively large amounts of medium must be readied for the wet calibration. Thus, the assignee has a calibration plant in Cernay, France, in which medium for calibration is stored in a 20 m high water tower. Using a revolver, the measuring tubes to be calibrated are brought into position for the medium to flow through. This plant can calibrate measuring tubes up to a diameter of 2000 mm.

Apart from the high costs for the construction of such a calibration plant, a further problem arises, when the manufacture of the flow-measuring devices occurs at widely scattered production facilities. In order to avoid long transport distances and, therefore, long delivery times, a calibration plant must be placed near to each production facility.

Major problems are presented also by the re-calibration of flow-measuring devices already installed in plants of customers. These devices must be extracted from their installed locations, re-calibrated in the calibration plant, and then brought back and installed again.

An object of the invention is to provide a method for the theoretical, or dry, calibration of flow-measuring devices.

The object is solved by a method including the following method steps:
On the basis of predetermined, geometrical, production data of the flow-measuring device, information concerning the theoretical flow of the medium through the measuring tube is won;
the actual, geometrical, measurement data of the flow-measuring device are determined three-dimensionally;
on the basis of the actual, geometrical, measurement data, information concerning the actual flow of the medium through the flow-measuring device is won; and
on the basis of the information regarding the theoretical flow, and the actual flow, of the medium through the flow-measuring device, a correction, or calibration, factor M is determined for the flow-measuring device.

According to an advantageous, further development of the method of the invention, the actual, geometrical, measurement data are determined by a three-dimensional scanning. For example, the scanning of the flow-measuring device occurs by means of electromagnetic waves or by means of a mechanical scanning head. Corresponding scanning devices are available from the firm Faro Technologies, Inc.

A preferred embodiment of the method of the invention provides that the flow-measuring device, or the measuring tube, is simulated by a mathematical model. Especially, the average inner cross section of the measuring tube is determined with high precision by the model.

Additionally, in order to achieve a high accuracy, the following variables—as required, in various combinations—are considered in the mathematical model:
a) the angles W1, W2 of incidence and emergence between ultrasonic sensors and the medium;
b) the separations S1, S2 between two sound emitting surfaces, or two sound receiving surfaces, as the case may be, of the ultrasonic sensors, which alternately emit and receive;
c) the radial separations H, F of the sound paths of the ultrasonic measuring signals of two ultrasonic sensors about the central axis of the measuring tube;
d) the positions of the emitting and receiving surfaces of the ultrasonic sensors relative to the flowing medium or to the inner surface of the measuring tube; and
e) the cross sectional area A of the section of the measuring tube lying between the two ultrasonic sensors and through which the medium flows.

A preferred further development of the method of the invention provides that the actual, average cross sectional area of the measuring tube is determined by measuring the three-dimensional coordinates of a plurality of scanning points lying in at least two parallel cross sectional planes of the measuring tube lying transversely to the stream direction. Additionally, the three-dimensional coordinates of the sound emitting and receiving surfaces of the ultrasonic sensors are determined.

Beyond this, an advantageous embodiment of the method of the invention provides that, for determining the three-dimensional coordinates of the midpoints of the corresponding sound emitting and receiving areas, a setup gage is used, in place of an ultrasonic sensor. Instead of the ultrasonic transducer in the form of e.g. a piezoelectric element, the setup gage has a specially embodied unit, which, in effect, simulates the ultrasonic transducer. If the three-dimensional scanning is done mechanically, then the setup gage has a cone-shaped element of defined shape. Especially is this cone-shaped element so embodied that the midpoint of a ball, which corresponds to the scanning head of the three-dimensional scanning device, lies in the midpoint of the sound emitting, or sound receiving, surface, as the case may be, of the corresponding ultrasonic sensor, upon its contacting of the cone.

If the three-dimensional scanning is done electromagnetically, especially optically, then the setup gage has a correspondingly embodied reflector, e.g. a cat's eye reflector or a cube-corner reflector with three perpendicular surfaces. As actual measured value, which represents the exact position of the ultrasonic sensor, the coordinates of that position are stored, at which the radiation reflected from the reflector is maximum.

On the basis of the angle of emergence, and the angle of incidence, of the sound, as well as on the basis of the actual, average, inner diameter of the measuring tube determined by the three-dimensional scanning, the sound path, and, therewith, the travel time of the ultrasonic measuring signals between two ultrasonic sensors, can be determined very accurately. In order to yet further reduce the measurement error that arises by application of the model, it is prudent to consider other disturbance variables.

In the case of ultrasonic flow measuring devices, the flow of the medium through a measuring tube is determined by a time-of-flight measurement. To this end, the travel times tᵤₚ(0) and t_{down}(0) between the two ultrasonic sensors are measured in the stream direction and counter to the stream direction.

The times are, however, still burdened with additional delay times tᵥ, which are caused by the ultrasonic sensors, the cables and the electronics. These delay times must be subtracted from the travel times determined on the basis of the three-dimensional scanning. Therefore, one obtains for travel time in the medium the following values:
t_{down}(1)=t_{down}(0)−tᵥ
tᵤₚ(1)=tᵤₚ(0)−tᵥ
By the three-dimensional scanning of the sound emitting and sound receiving surfaces and with knowledge of the delay time, the travel time, which the ultrasonic measuring signals require on the sound path S between two ultrasonic sensors can be determined very accurately. By comparing the theoretical travel time and the actually measured travel time, the velocity of sound in the medium, c_{Medium}, can then be determined by the following formula, in which F(v) represents a velocity-dependent term, which depends on the ratio of the velocity of the medium to the sound velocity:

$${c}_{Medium} = \frac{S}{2} ( \frac{1}{{t}_{up} ( 1 )} + \frac{1}{{t}_{down} ( 1 )} ) * F ( v )$$

F(v) is equal to 1 for v=0, i.e., for v<<c_{Medium}, F(v) is approximately equal to 1.

Furthermore, the separation R/2 between the sound emitting, or sound receiving, as the case may be, surface of an ultrasonic sensor and the inner surface of the measuring tube is taken into consideration. It is assumed that, in this region of a given sound path, the flow velocity of the medium is at least approximately equal to zero. The corrected times tᵤₚ and t_{down} are given on the basis of the following formulas:

$${t}_{up} = {t}_{up} ( 1 ) - \frac{R}{{c}_{Meduim}}$$

The flow profile, which represents the radial dependence of the flow velocity of a medium in a measuring tube, looks very different, depending on whether the flow is laminar or turbulent. If the radial separation of a pair of ultrasonic sensors is known accurately from the three-dimensional scanning, then, with knowledge of the Reynolds number, a profile correction factor K can be calculated giving the ratio of the measured velocity to the average velocity v_{M} of the medium:
v=v_{M}*K
The theoretical flow is calculated as follows—for example, for the sound path 1—wherein L1 represents the length of the sound path, K1 the profile correction factor of the sound path 1, W1 the angle to the tube axis, t1ᵤₚ and t1_{down} the travel times of the ultrasonic measuring signals for the sound path 1, and A the cross sectional area of the measuring tube:

$${Q}_{1} = \frac{L 1}{2 * cos ( W 1 )} * A * K 1 * ( \frac{1}{t {1}_{down}} - \frac{1}{t {1}_{up}} )$$

The measurement becomes yet greater in accuracy, when a plurality of sound paths are present at different separations from the central axis of the measuring tube. Depending on the separation of the ultrasonic sensors from the central axis of the measuring tube, the travel times are weighted with wi on the basis of the following formula:

$${Q}_{calculated} = {\sum }_{n} {w}_{i} * {Q}_{i}$$

Via the ratio of the individual velocities at different separations of the sound paths from the middle of the tube, the velocity profile of the medium can be determined. With the help of these measured values, the flow can be still better captured, also corrected, in the critical velocity region between pure laminar flow and turbulent flow. In the mathematical model, the measured values won by the three-dimensional scanning are used. These deviate usually from the predetermined manufacturing measured data. The determined correction factor M then describes the measure for the deviation, or individual calibration factor, of the ultrasonic flow measuring device. This calibration factor is stored in the ultrasonic flow measuring device and enters subsequently into the determination of flow.

The invention will now be explained in greater detail on the basis of the drawings, the figures of which show as follows:

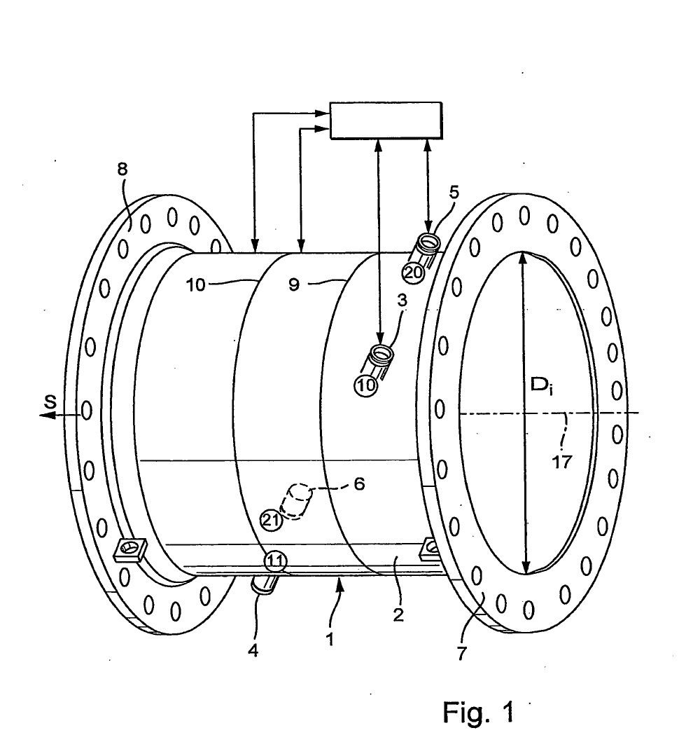

FIG. 1 a perspective view of an ultrasonic flow measuring device;

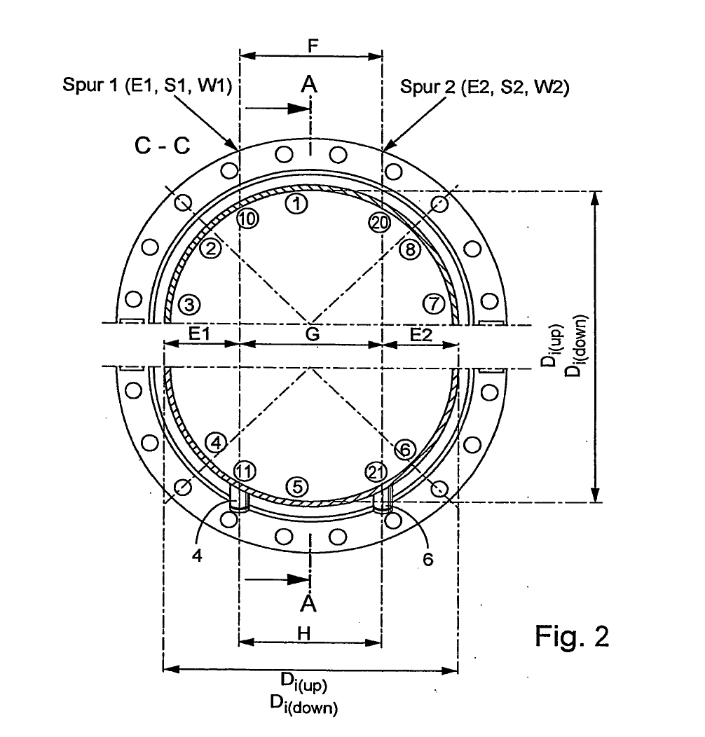

FIG. 2 a cross section through the ultrasonic flow measuring device of FIG. 1;

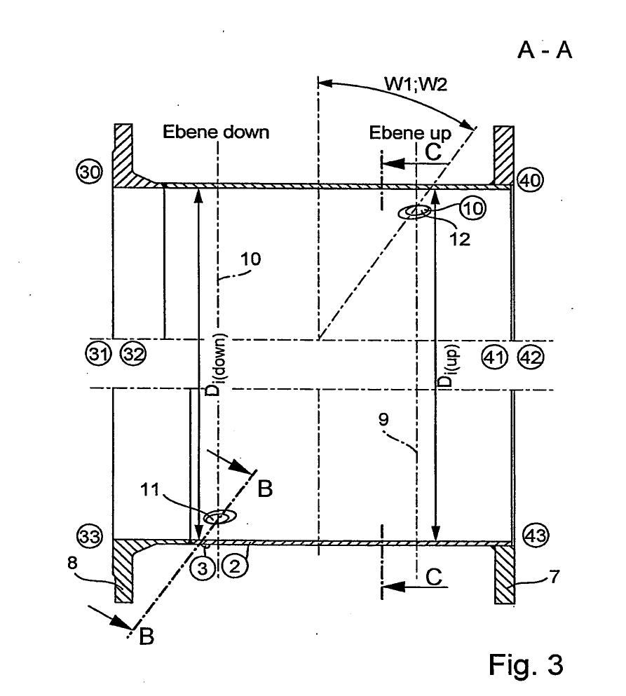

FIG. 3 a longitudinal section taken according to the cutting plane A-A of FIG. 2;

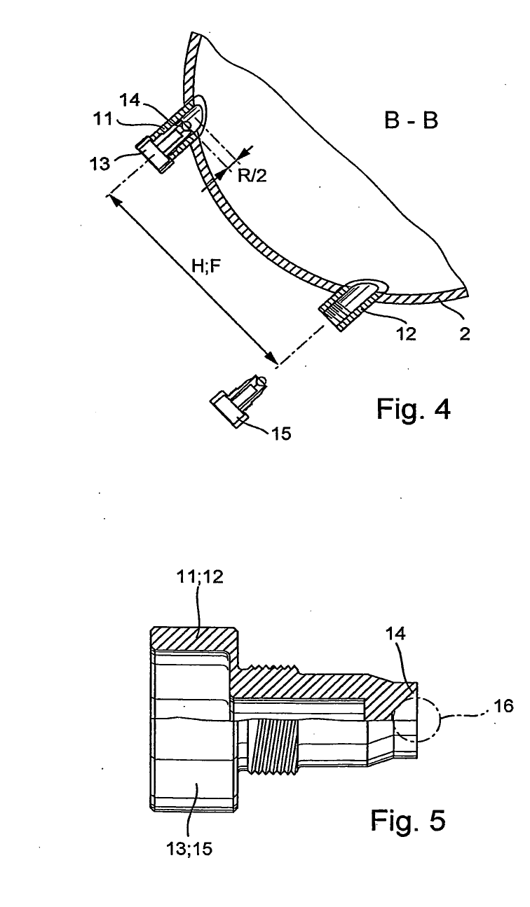

FIG. 4 a section taken according to the cutting plane B-B of FIG. 3; and

FIG. 5 a side view of the setup gage of the invention.

FIG. 1 is a perspective view of an ultrasonic flow measuring device 1 with two sound paths, i.e. two measuring channels. The two pairs of ultrasonic sensors 3, 4; 5, 6 are preferably arranged at positions of about 50% of the radius of the measuring tube 2. For a two beam arrangement of ultrasonic sensors 3, 4; 5, 6, this positioning is of advantage, since, in such case, flow velocity is relatively largely independent of the Reynolds number, or the viscosity, of the medium.

FIG. 2 is a cross section through the ultrasonic flow measuring device of FIG. 1. FIG. 3 shows a longitudinal section taken according to the cutting plane A-A of FIG. 2. As already described above, the average inner cylinder of the measuring tube 2 is determined by scanning three-dimensional coordinates of measuring points in two planes 9, 10. The circled numbers 1 to 8 designate the three-dimensionally scanned, measuring points used to determine the inner diameter Di in the two planes: Plane up 9 and plane down 10 are used. Of course, the determination of the inner diameter Di in the two planes 9, 10 becomes more accurate, the greater the number of measuring points considered. In the illustrated case, the planes 9, 10 are defined by the points of penetration of the ultrasonic sensors 3, 4; 5, 6.

The circled numbers 10, 11, 20, 21 serve for determining the sound path, respectively trace 1, respectively trace 2. Especially, on the basis of these values, the radial separations H and F of the sound paths of the ultrasonic measuring signals of the pairs of ultrasonic sensors 3, 4; 5, 6 about the central axis 17 of the measuring tube 2 are determined. If the separations H and F are known, then also the incidence, and emergence, beam angles W1, W2 of the ultrasonic sensors 3, 4; 5, 6 can be calculated.

The three-dimensional scanning also permits highly accurate measurement of the sealing faces of the flanges 7, 8. Serving for determination of the sealing faces of the flanges 7, 8 are the measuring points designated in FIG. 3 by the circled numbers 30-33 and 40-43.

FIG. 4 shows a section according to the cutting plane B-B of FIG. 3. Especially, FIG. 4 illustrates the placement of setup gages 13, 15 in the corresponding sensor ports 11, 12. FIG. 5 shows a side view of the setup gage 13, 15 of the invention. The setup gage 13, 15 is partially shown in section in FIG. 5. The setup gage 13, 15 of the invention is dimensioned analogously to an ultrasonic sensor 3, 4, 5, 6 usable in the flow measuring device 1 and can, therefore, be assembled into the sensor ports 11, 12 without problem. In the case of the setup gage 13, 15, which is designed for position determination by means of a mechanically working, scanning device, a cone-shaped element 14 is provided instead of the usually piezoelectric, ultrasonic transducer. The cone-shaped element 14 is so dimensioned that the midpoint of a ball 16 of defined diameter, serving as placeholder for the scanning head of the mechanical scanning device, lies in the midpoint of the sound emergence surface, or the sound incidence surface, as the case may be, of the corresponding ultrasonic sensor 3, 4, 5, 6, upon contacting of the cone-shaped element 14. In this way, the position of the ultrasonic sensor 3, 4, 5, 6 can be determined with high accuracy.

By means of the method of the invention, and especially with use of the setup gage 13, 15 of the invention, a dry calibration of the flow measuring device 1 can be performed quickly and simply. Especially, it becomes possible to do the calibration, or recalibration, on site.

### List of Reference Characters

1 ultrasonic flow measuring device
2 measuring tube
3 ultrasonic sensor
4 ultrasonic sensor
5 ultrasonic sensor
6 ultrasonic sensor
7 flange
8 flange
9 plane up
10 plane down
11 sensor port
12 sensor port
13 setup gage
14 cone
15 setup gage
16 ball
17 central axis

1-10. (canceled)

11. A method for calibrating an ultrasonic flow measuring device, which includes a measuring tube, at least two ultrasonic sensors and a control/evaluation unit, comprising the steps of:
emitting and/or receiving ultrasonic measuring signals using the ultrasonic sensors;
determining the flow of a medium in the measuring tube on the basis of the travel times of the ultrasonic measuring signals, which traverse the measuring tube in the stream direction and counter to the stream direction;
winning information concerning the theoretical flow of the medium through the measuring tube on the basis of predetermined, geometric, production data of the flow measuring device;
determining the actual, geometric measurement data of the flow measuring device three-dimensionally; and
winning information concerning the actual flow of the medium through the flow measuring device on the basis of the actual, geometric measurement data; and
determining a correction, or calibration, factor for the flow measuring device on the basis of the information concerning the theoretical flow, and the actual flow, of the medium through the flow measuring device.

12. The method as claimed in claim 11, further comprising the step of:
determining the actual, geometric measurement data by a three-dimensional scanning of the flow measuring device.

13. The method as claimed in claim 12, wherein:
said scanning of the flow measuring device is performed by means of electromagnetic waves or by means of a mechanical scanning head.

14. The method as claimed in claim 12, further comprising the step of:
simulating the flow measuring device, or the measuring tube, by a mathematical model.

15. The method as claimed in claim 14, wherein:
in the mathematical model, the following variables are taken into consideration:
the angle of incidence and/or angle of emergence between ultrasonic sensor and the medium;
the separation between two sound emitting, respectively two sound receiving, surfaces of the ultrasonic sensors, which alternately emit and receive;
the radial separation of the sound paths of the ultrasonic measuring signals of two ultrasonic transducers about the central axis of the measuring tube;
the positions of the emitting and receiving surfaces of the ultrasonic sensors relative to the flowing medium or to the inner wall of the measuring tube; and
the cross sectional area of the section of the measuring tube lying between the two ultrasonic transducers and flowed-through by the medium.

16. The method as claimed in claim 12, wherein:
the actual inner cross sectional area of the measuring tube is determined by measuring the three-dimensional coordinates of a plurality of scanning points lying in at least two parallel cross sectional planes of the measuring tube transverse to the stream direction of the medium.

17. The method as claimed in claim 12, further comprising the step of:
determining the three-dimensional coordinates of the sound emergence, respectively sound incidence, surfaces of the ultrasonic sensors are determined.

18. The method as claimed in claim 17, wherein:
for the purpose of determining the three-dimensional coordinates of the midpoint of the sound emergence, or sound incidence, surface of an ultrasonic sensor, a setup gage is used, in which, instead of an ultrasonic transducer, a cone of defined shape is used, which is so embodied, that the midpoint of a ball of defined diameter lies in the midpoint of the sound emergence, or sound incidence, surface of the corresponding ultrasonic sensor, when the ball contacts the cone.

19. A setup gage for performing a method comprising the steps of:
emitting and/or receiving ultrasonic measuring signals using the ultrasonic sensors;
determining the flow of a medium in the measuring tube on the basis of the travel times of the ultrasonic measuring signals, which traverse the measuring tube in the stream direction and counter to the stream direction;
winning information concerning the theoretical flow of the medium through the measuring tube on the basis of predetermined, geometric, production data of the flow measuring device;
determining the actual, geometric measurement data of the flow measuring device three-dimensionally; and
winning information concerning the actual flow of the medium through the flow measuring device on the basis of the actual, geometric measurement data; and
determining a correction, or calibration, factor for the flow measuring device on the basis of the information concerning the theoretical flow, and the actual flow, of the medium through the flow measuring device;
the setup gauge having: a cone-shaped element, which is so dimensioned, that the midpoint of a ball, whose diameter corresponds to the diameter of a scanning head of a mechanical scanning device, lies in the midpoint of the sound emergence, or sound incidence, surface of the ultrasonic sensor, when the ball contacts the cone-shaped element.

20. The setup gage as claimed for carrying-out the method as claimed in claim 9, wherein:
instead of the ultrasonic transducer, a retroreflector element is provided, which is so embodied, that impinging electromagnetic radiation from a scanning device is reflected back, into the scanning device.
